(19) United States
(12) Patent Application Publication
(10) Pub. No.: US 2004/0096271 A1
(43) Pub. Date: May 20, 2004

(54) Quill shaft tensioning coupling

(76) Inventors: Rainer Peter, Obernburg (DE); Rainer Klein, Obernburg (DE); David Alan Ballard, Greenville, SC (US); Thomas Martin Cappel, Simpsonville, SC (US); Hubert Leibold, Forst (DE)

Correspondence Address: Nexsen Pruet Jacobs & Pollard, LLC, P.O. Box 10107, Greenville, SC, 29603, US

(21) Appl. No.: 10/299,139

(22) Filed: Nov. 19, 2002

(51) Int. Cl. B25G 3/20; F16B 7/04; F16B 2/18; F16B 2/14

(52) U.S. Cl. 403/374.3

(57) ABSTRACT

A tensioning coupler for a quill and shaft employs a yoke around the circumference of a quill, a first circumferential pressure ring and a second tensioning ring each of which has a projected conical portion which overlap each other when installed. Both rings have slots to allow them to be opened or closed slightly as the tensioning ring is drawn into the pressure ring.

### BACKGROUND OF THE INVENTION

1. Field of the Invention

This invention relates to methods for attaching a quill shaft to another shaft using a tensioning device to produce an interference fit.

2. Background in Prior Art

U.S. Pat. No. 4,220,064 to Potter discloses a method for locking a sleeve to a shaft which requires that flats or grooves be formed into the shaft. U.S. Pat. No. 4,367,053 to Stratienko et al. discloses a keyless mount for a hub on a shaft using cylindrical wedge rings and an annular flange bolted to the hub at the shaft stub.

U.S. Pat. No. 4,626,114 to Phillips discloses a tapered sleeve and flange for mounting a quill in a speed reduction gearbox whereby the flange is bolted to a bushing ring on the quill. A keyway is also employed. U.S. Pat. No. 5,188,480 to Okuno discloses the use of wedge-shaped ring nuts to provide a tensioned interference between a shaft and a gear carried thereon. U.S. Pat. No. 5,476,337 to Mullenberg teaches the use of a conical ring and a casing to lock a gear onto a solid shaft. U.S. Pat. No. 5,496,127 to Muller discloses a system for attaching a quill to a shaft using a tension cone, tension rings and a counter holding ring held on the quill by a circlip.

U.S. Pat. No. 5,667,333 to Phillips discloses a method for locking a quill onto a shaft using a first internal wedge core, a conical wedge between the first internal wedge held in place by bolts which draw the wedge into the bore of the quill against a collar held in place by a snap ring. A key passes from internal shaft to outer quill through the wedge pieces. U.S. Pat. No. 5,765,961 also to Phillip teaches a related locking system without the first internal wedge. U.S. Pat. No. 5,951,198 to Phillip discloses a related system with a shorter conical wedge.

U.S. Pat. No. 6,099,199 to Mullenberg teaches attaching a hub to a shaft using opposing conical pieces drawn together by a through bolt. U.S. Pat. No. 6,196,759B1 to Cassarotto teaches connecting a shaft to a blind quill using bolts entering the walls of the quill. U.S. Pat. No. 6,261,185 B1 to Peterson et al. teaches connecting a solid shaft to a hollow drive shaft using a pair of slotted cylindrical wedges and pulling the inner wedge into the outer wedge using a nut threaded onto the inner cylindrical wedge.

A quill shaft is conventionally used in mechanical transmissions as a means for connecting gears to input and output shafts. The quill is a hollow shaft which is carried within the transmission casing and which carries an input or an output gear. The prime mover and the driven device are not particularly limited except that both the input and output are twisting forces.

In the interest of compact design, light weight, low rotating masses and friction minimalization, it is preferred that the wall thickness of the quill should be at a minimum. The traditional use of machined key ways and pins is not feasible with thin walled quills. There is also a need for a system which allows for changes in the diameter of input and output shafts to enable the gear reducer to be used with a variety of motors and driven devices manufactured by different manufacturers. These changes should be easily made “in the field” without the need to open the gearbox.

There exists also the need for a method of connecting a thin walled quill to either a hollow or a solid input or output shaft in a manner which allows maintenance and/or replacement on a routine basis.

### BRIEF DESCRIPTION OF THE INVENTION

It is an object of this invention to provide a method for connecting a quill to a solid or hollow input or output shaft without the use of keyways and pins. It is a further objective of this invention to provide a method for connecting a quill to a shaft which may be disassembled and replaced without the use of impacting devices or pullers.

It is a further objective of this device to provide an interference fit in such manner as to evenly distribute the tensional load around the quill. It is yet a further objective of this invention to provide a tensioning connector for a quill which is inherently or readily dynamically balanced.

These and other objectives may be achieved by providing a tensioning connector consisting of a first tensioning ring having a projected split cone insertable between a quill and a tubular inserted shaft, a second tensioning ring having a split cone insertable between the first ring and the inserted shaft, an annular journal surrounding the outer surface of the quill in the region where the cones of the first and second rings are inserted and tensioning means to draw the second tensioning cone into compressive contact with the first tensioning ring and cone.

### BRIEF DESCRIPTION OF THE DRAWINGS

FIG. 1 is a cross-section of the connector according to this invention.

FIG. 2 shows the relationship between a quill and shaft prior to the installation of the connector.

FIG. 3 shows the first step in the installation of the connector.

FIG. 4 shows the second step in the installation of the connector.

FIG. 5 shows the third step in the installation of the connector.

FIG. 6 shows the fourth step in the installation of the connector.

FIG. 7 shows the completed connector properly installed.

### DETAILED DESCRIPTION OF THE INVENTION

The connector according to this invention creates a compression or interference fit between a shaft and a quill. The connector may be installed and removed without special tools and does not require the quill to be removed from the transmission device in which it is used. The most common utilization for this connector is expected to be a speed reducer for manufacturing lines in processing plants although the utilization is not specifically limited. Furthermore, the input or output shaft to which the quill is connected may be solid or hollow so long as it's cross-section is substantially circular.

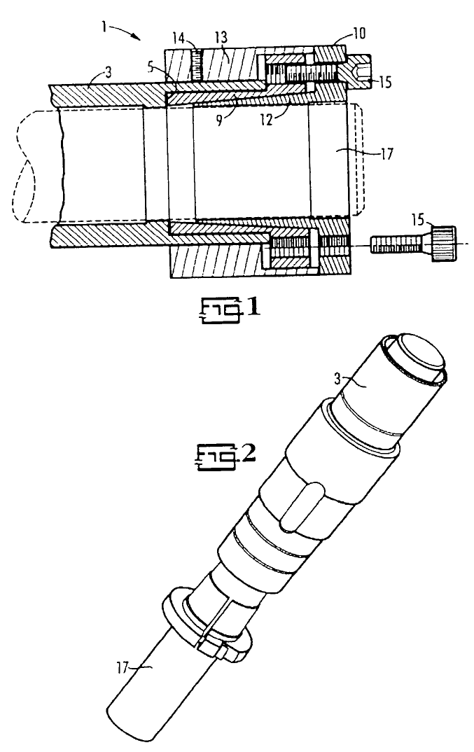

FIG. 1 is a cross-section of the connector. Connector 1 is shown attaching a quill shaft 3 to an inner shaft 17. The connector is best described by the manner of it's assembly.

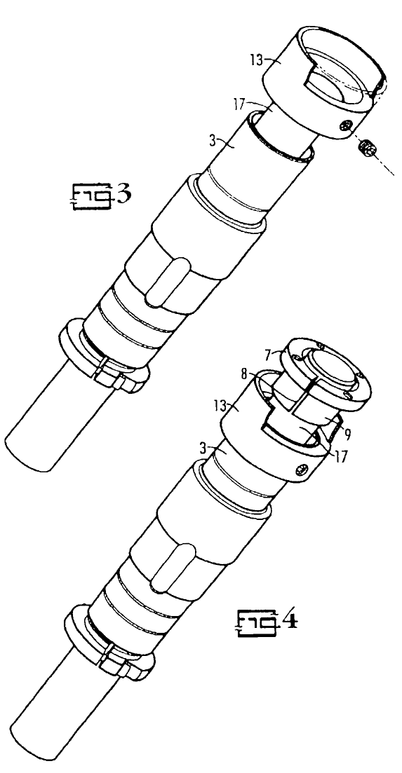

FIG. 2 shows a quill shaft 3 and an inner shaft 17.

FIG. 3 shows a yoke 13, which is slid over the end of quill 3. The yoke is sized for a sliding fit around the quill and will serve as a reactionary support to control or direct or dictate axial movement between items 7 and 10, thus not creating an axial tension or force between the quill 3 and inner shaft 17. Once properly located, a setscrew, 14 shall be tightened to maintain location.

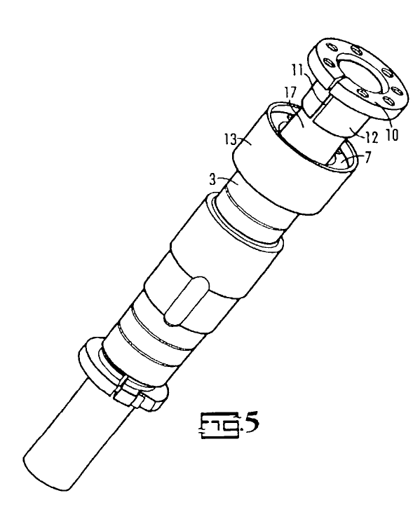

FIG. 4 shows a circumferential tensioning ring 7 being slid onto shaft 17. This ring has a slot 8, which allows the ring to open and close slightly as will be discussed later. The circumferential pressure ring 7 is slid between the shaft and quill so that the conical front portion 9 comes into contact with the inner surface of quill shaft 3.

As shown in FIG. 5, second tensioning ring 10 having a slit 11 and a forward conical section 12 is slid onto the shaft so that the conical portion 12 is between the conical front portion 9 of the pressure ring and the shaft 17. At this point, and as shown in FIG. 1, the arrangement of components from the axis is the shaft 17, conical portion of the tensioning ring 12, the conical portion 9 of pressure ring 7, quill shaft 3 and yoke 13. As shown in FIG. 1, it is preferred that the quill be relieved to form a small step 5 for insertion of the front portions of the pressure ring and tensioning ring and so that the shaft is a non-binding contact with the quill.

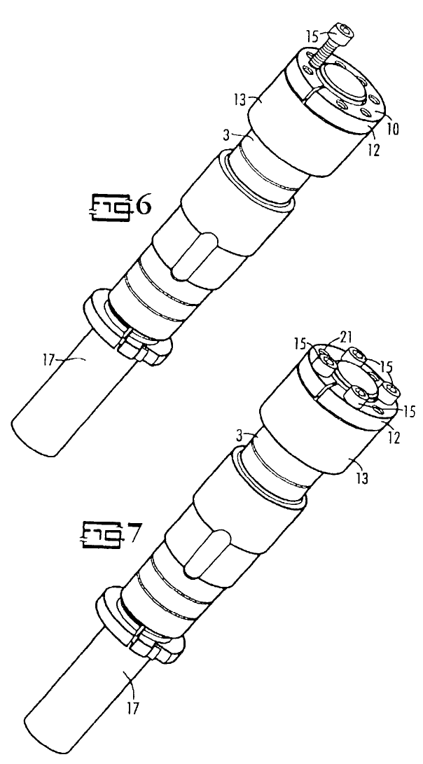

Once the components of the coupling are in place, fastening means such as bolts 15 are inserted through the tensioning ring 10 and into the pressure ring 7 (FIG. 6). As the tensioning ring is drawn into the pressure ring, the pressure ring is forced radially outwardly toward the yoke 13 and the tensioning ring is pushed radially inwardly toward the shaft. When fully tightened or as shown in FIG. 7, the coupling provides a tight tensioned interference fit between quill and shaft.

In the preferred embodiment, the tensioning ring has at least two threaded bores which do not have corresponding threaded bores in the pressure ring (i.e. they are blinded). To disassemble the device, it is merely necessary to remove bolts 15 which draw the rings together and to insert the same bolts into the blinded thread bores 21 of the tensioning ring. As the bolts are tightened they serve as a puller to separate the pressure ring from the tensioning ring and allow for the components to be conventionally removed.

Changes and departures in this invention may be made by those skilled in the art without departing from the spirit and scope thereof. Therefore, the invention is not intended to be limited by the description and figures but are those as set forth in the following claims.

We claim:

1. A coupling device for attaching a quill shaft to an inner shaft comprising:
a first tensioning ring (7) having a split flange and a split conical projection (9) insertable within a quill shaft (3);
a second tensioning ring (10) having a split flange and a split conical portion (11) insertable between said first tensioning ring and an inner shaft (17);
a yoke (13) slidably engaging the circumference of said quill shaft;
fastening means (15) for drawing said second tensioning ring into said first tensioning ring.

2. A coupling device according to claim 1 further comprising blind threaded bores
(21) in said second tensioning ring flange for removing said second tensioning ring from said first tensioning ring.

3. A coupling device according to claim 1 that does not require the aid of keys, keyways and/or pins for the directionally independent transmission of torque.
